(19) United States
(12) Patent Application Publication
(10) Pub. No.: US 2025/0308149 A1
(43) Pub. Date: Oct. 2, 2025

(54) LIGHT CULLING FOR DECOUPLED SHADING

(71) Applicants: Advanced Micro Devices, Inc., Santa Clara, CA (US); ATI Technologies ULC, Markham (CA)

(72) Inventors: Guennadi Riguer, Markham (CA); Michal Adam Wozniak, Santa Clara, CA (US)

(73) Assignees: Advanced Micro Devices, Inc., Santa Clara, CA (US); ATI Technologies ULC, Markham (CA)

(21) Appl. No.: 18/621,700

(22) Filed: Mar. 29, 2024

(51) Int. Cl. G06T 15/80; G06T 15/06

(52) U.S. Cl. CPC G06T 15/80; G06T 15/06

(57) ABSTRACT

A technique for rendering is provided. The technique includes generating a ray representative of an area of a tile of a shade space texture; and casting the ray into a scene of light volumes to generate a set of lights that contribute to shading operations of the tile. The tile is a tile to be shaded in a shade space shading operation. The ray is within the tile in world space. Intersection of the ray with a light volume is an indication that the tile is within the light volume. Identifying all light volumes that encompass a tile in this manner allows for identification of all lights that affect the tile, which allows for efficient shading operations to occur, as shading operations utilize information about which lights affect a tile to generate visual data for the tile.

### BACKGROUND

Three-dimensional graphics processing involves rendering three-dimensional scenes by converting models specified in a three-dimensional coordinate system to pixel colors for an output image. Improvements to three-dimensional graphics processing are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates a set of decoupled shading operations, according to an example;

FIG. 5 illustrates operations for the visibility pass and texture marking operations, according to an example;

FIG. 6 illustrates example shade space shading operations for the shade space shading operations of FIG. 4;

FIG. 7 illustrates an example reconstruction operation;

FIG. 8 illustrates an example scene showing operations for lighting by the shade space shading operation, according to an example;

FIG. 9 illustrates an example technique for generating a light list for a tile of a shade space texture, according to an example;

FIG. 10 illustrates several example schemes for casting rays to identify lights to be placed into light lists;

FIG. 11 is an illustration of a bounding volume hierarchy, according to an example; and

FIG. 12 illustrates an operation for building light lists, according to an example.

### DETAILED DESCRIPTION

A technique for rendering is provided. The technique includes generating a ray representative of an area of a tile of a shade space texture; and casting the ray into a scene of light volumes to generate a set of lights that contribute to shading operations of the tile. The tile is a tile of samples to be shaded in a shade space shading operation. The ray is bound within the tile in world space. Intersection of the ray with a light volume is an indication that the tile is within the light volume. Identifying all light volumes that encompass a tile in this manner allows for identification of all lights that affect the tile, which allows for efficient shading operations to occur, as shading operations utilize information about which lights affect a tile to generate visual data for the tile.

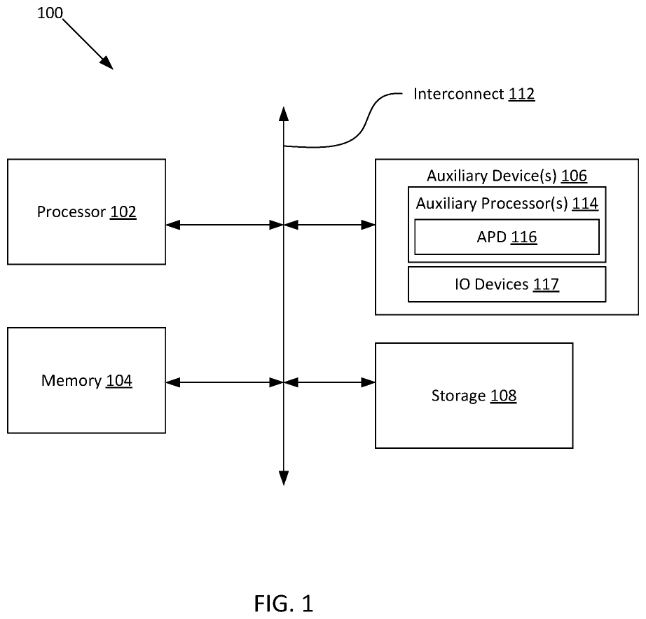

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

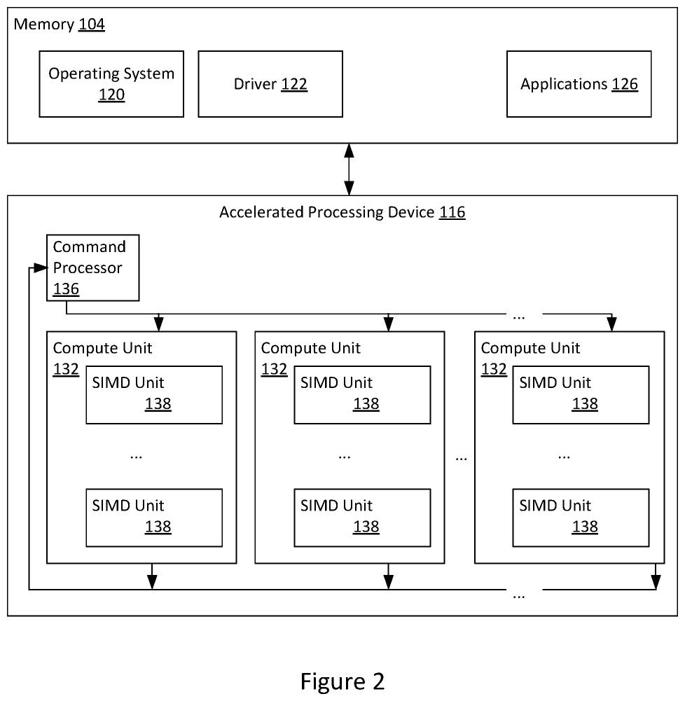

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

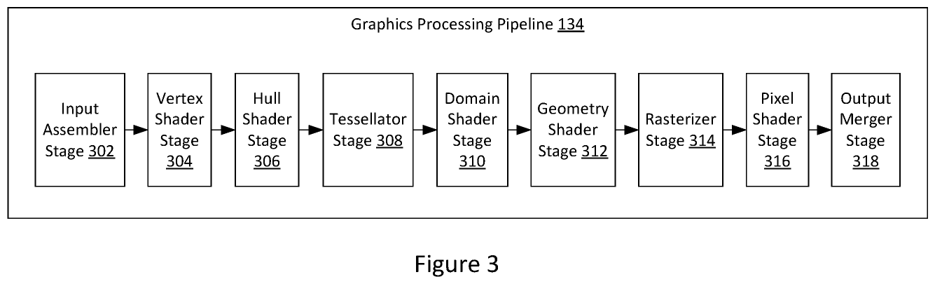

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

It is possible to perform rendering in a “decoupled” manner. Decoupled rendering involves decoupling sample shading operations from other operations in the pipeline such as geometry processing and actual application of the shading results to the objects of a three-dimensional scene. In “typical” rendering such as forward rendering, a rendering pipeline processes triangles, transforming the vertices of such triangles from world space to screen space, then rasterizes the triangles, generating fragments for shading by the pixel shader. The pixel shader shades such fragments and outputs visible fragments to the pixel buffer for final output. As can be seen, in such rendering operations, the rate at which pixel shading operations occur is directly related to the rate at which geometry sampling and final image generation is performed. Advantage can be gained by decoupling the rate at which shading operations occur from the sampling rate of the rendered image. Specifically, it might be possible to reduce the heavy workload of complex pixel shading operations while still generating frames at a high frame rate to reflect changes in geometry (e.g., camera position, rotation and scene geometry movement, rotation, and scaling) quickly over time.

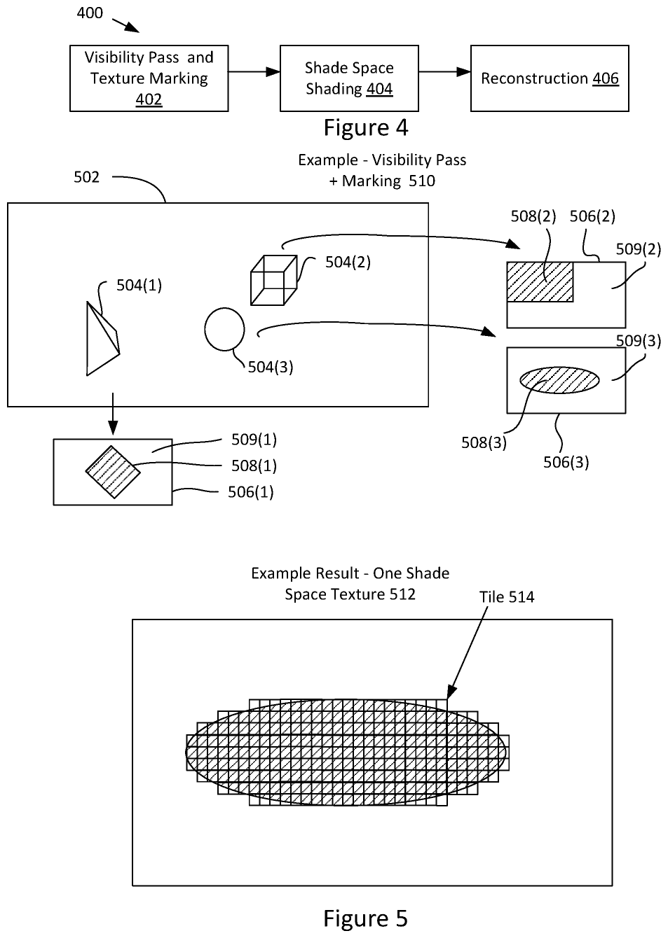

FIG. 4 illustrates a set of decoupled shading operations 400, according to an example. The set of decoupled shading operations 400 includes a visibility pass and shade space marking operation 402, a shade space shading operation 404, and a reconstruction operation 406. In some examples, any of these operations is performed by one or more of software executing on a processor (such as the compute units 132), hardware (e.g., hard-wired circuitry), or a combination of software and hardware. In various examples, any of this software includes software executing on the processor 102 (e.g., an application), software executing in the APD 116 (e.g., shader programs), any other software, or any combination thereof. In various examples, the hardware includes any of the processors illustrated (e.g., processor 102, APD 116), or other circuitry or processors not illustrated. In this disclosure, phrases such as “the APD 116 performs a task” is sometimes used. This should be understood as meaning that any technically feasible element (e.g., the software or hardware) performs such task. In addition, although various operations are described as being performed by the APD 116, in other examples, such operations are performed by other elements such as the processor 102 or another hardware or software element not described. Herein, where it is stated that software performs an operation, this should be understood as meaning that software executing on a processor performs the operation and thus that the processor performs that operation.

As a whole, the operations of FIG. 4 involve three “phases”: a visibility determination phase, a shade space texture shading phase and a reconstruction phase. The shade space texture shading phase includes shading onto shade space texture for a scene. The shade space textures can be thought of as “canvases” to which shading operations are applied. The canvases are applied to the objects of a scene in the reconstruction phase. It is possible to decouple the rate at which the shade space shading phase occurs from the rate at which the reconstruction phase occurs, providing benefits such as reduction of shading operation workload while still allowing for generating output frames at a high rate.

As described above, the objects of a scene each have one or more shade space textures. The shade space textures are mapped to the surfaces of such objects and colors in the shade space textures are applied to the objects during reconstruction 406. Utilizing the shade space textures in this manner allows for shading operations (e.g., the shade space shading operations 404) to occur in a “decoupled” manner as compared with the other rendering operations.

The visibility pass and shade space marking 402 involves marking which portions of the shade space textures are visible in a scene. In some examples, the scene is defined by a camera and objects within the scene, as well as parameters for the objects. In some examples, a portion of a shade space texture is visible in the event that the portion appears in the final scene. In some examples, the portion appears in the final scene if the portion is within the camera view, faces the camera, and is not occluded by other geometry. In some examples, the visibility pass and shade space marking operation 402 results in generating groups of samples, such as tiles, that are to be shaded in the shade space shading operation 404. Each tile is a set of texture samples of a shade space texture that is rendered into in the shade space shading operation 404 and then applied to the geometry in the reconstruction 406 operation. In some examples, each such tile is a fixed size (e.g., 8×8 texture samples or “texels”). In various examples, the visibility pass and shade space marking 402 is performed by a forward rendering pass, ray casting, or any other technically feasible technique that achieves determination of which portions of the shade space textures are visible in a scene.

The shade space shading operation 404 includes shading the visible portions of the shade space textures. In some examples, these shading operations are operations that are typically applied in the pixel shader stage 316 in “typical” rendering. Such operations include texture sampling (including filtering), applying lighting, and applying any other operations that would be performed in the pixel shader stage 316.

The reconstruction operation 406 includes applying the shade space textures to the geometry of the scene to result in a final image. In some examples, the reconstruction operation 406 processes the scene geometry through the world space pipeline, including applying the operations of the vertex shader stage 304 (e.g., vertex transforms from world-space to screen space) and the rasterizer stage 314 to generate fragments. The reconstruction operation 406 then includes applying the shade space texture to the fragments, e.g., via the pixel shader stage 316, to produce a final scene which is output via the output merger stage 318. Note that the operations of the pixel shader stage 316 in reconstruction 406 are generally much simpler and less computationally intensive than the shading operations that occur in the shade space shading operations 404. For example, while the shade space shading operations 404 perform lighting, complex texture filtering, and other operations, the reconstruction operation 406 is able to avoid many such complex pixel shading operations. In one example, the reconstruction operation 406 performs texture sampling with relatively simple filtering and omits lighting and other complex operations.

As stated above, it is possible to apply the shade space shading operation 404 at a different frequency than the reconstruction operation 406. In other words, it is possible to use the information generated by the shade space operation 404 in multiple successive reconstruction operations 406 (or reconstruction “frames”). Thus, it is possible to reduce the computational workload of the complex shading operations 404 while still generating output frames relatively quickly. The decoupled shading operations 400 will now be described in greater detail.

FIG. 5 illustrates operations for the visibility pass and shade space marking operations 402, according to an example. Herein, the term “visibility pass 402” is used interchangeably with “visibility pass and texture marking operations 402.” The example visibility pass 402 is performed for a scene 502 which includes a number of objects 504. In addition, each object 504 has an associated shade space texture 506 which has a visible portion 508 and a non-visible portion 509. As can be seen, the example visibility pass 510 results in the designation of the visible portion 508 of the associated shade space texture 506.

In an example 512, the visibility pass 402 designates the visible portions 508 of the shade space textures 506 by generating tiles 514 that cover the visible portions in the following manner. The visibility pass 402 performs the operations of the graphics processing pipeline 134 in a simplified mode. Specifically, the visibility pass 402 generates tiles for the portions of the shade space texture 506 that are visible in the scene. Each tile 514 represents a portion of the shade space texture 506 that is to be shaded in the shade space shading operation 404. Tiles that are not generated are not shaded in the shade space operation 404.

In some examples, the visibility pass 402 generates tiles by using the graphics processing pipeline 134. More specifically, the geometry of the scene 502 is processed through the graphics processing pipeline 134. Information associating each fragment with a shade space texture flows through the graphics processing pipeline 134. When the final image is generated, this information is used to identify which portions of which shade space textures 506 are actually visible. More specifically, because only visible fragments exist in the final output image, the information associated with such fragments is used to determine which portions of the shade space textures 506 are visible.

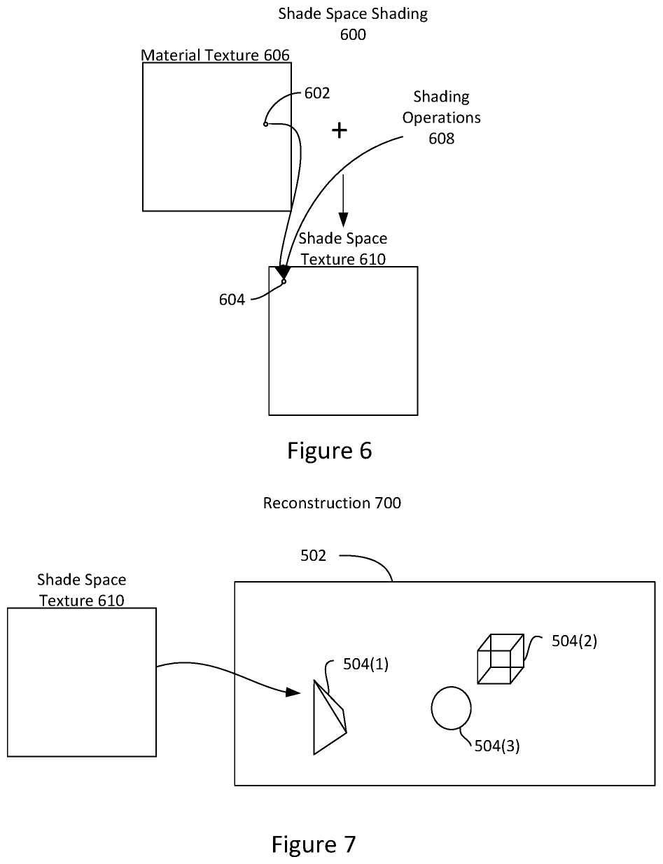

FIG. 6 illustrates example shade space shading operations 600 for the shade space shading operations 404 of FIG. 4 in accordance with a previously performed visibility determination (e.g., operation 402). The APD 116 performs shade space shading 600 by sampling a material texture 606 within a sample area 602 to obtain a texture color and applying shading operations 608 (e.g., lighting and/or other operations) as a result to generate a shade space color sample 604 for the shade space texture 610. In some examples, the shade space shading operations 600 generates texels for the entirety of each of the tiles 514 that are generated as a result of the visibility pass 402. FIG. 7 illustrates an example reconstruction operation 700. In the reconstruction operation 700, the shade space texture 610 is applied to the objects 504 within the scene. As stated elsewhere herein, in some examples, this application is performed via relatively simple texture sampling operations during rendering that sample the shade space texture 610 in a relatively simple manner and apply such samples to the objects 504 of the scene 502.

As described elsewhere herein, the shade space shading operation 404 shades shade space textures, determining colors for such textures. One aspect of shading involves lighting. For example, lights in a scene can affect the apparent color of an object and thus the color generated for a shade space texture. In general, applying lights in shading involves identifying the lights in the scene that affect an item to be shaded, and applying the lighting contributions from such lights to the texels of the shade space texture. In tiled deferred or forward plus rendering, light lists are generated for a grid of tiles in screen space, and during shading of a pixel, the pixel shader checks the light list for the grid in which the pixel resides and applies the contributions of those lights to the pixel. This technique is unavailable for decoupled rendering, however. Specifically, the stage at which lighting occurs—the shade space shading operation 404—does not occur in screen space. A different technique for lighting is therefore provided herein.

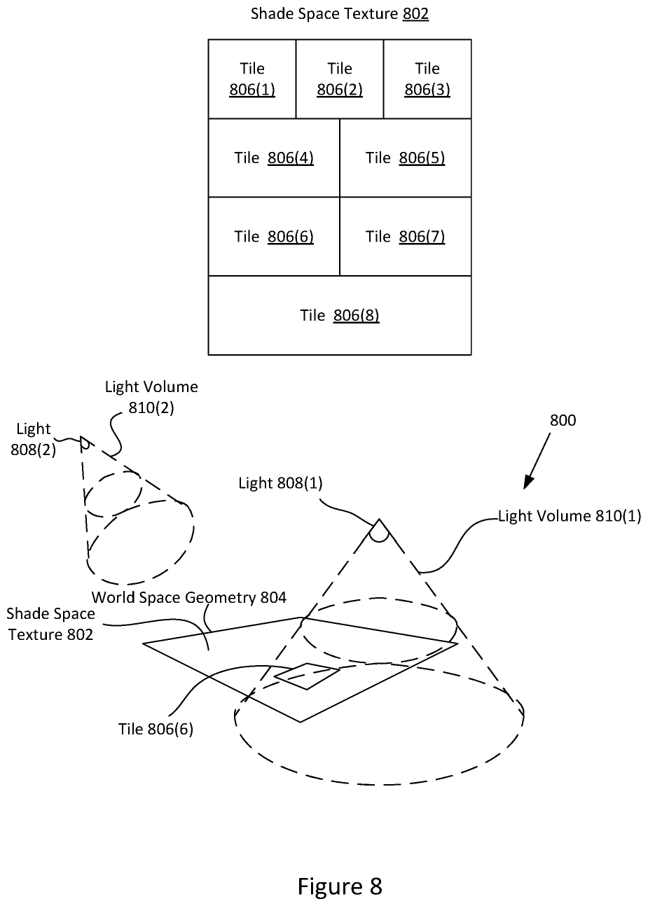

FIG. 8 illustrates an example scene 800 showing operations for lighting by the shade space shading operation 404, according to an example. The scene 800 includes an element of world space geometry 804 (e.g., a mesh of primitives). The shade space shading operation 404 involves shading a shade space texture 802 that is applied to the world space geometry 804 (e.g., a triangle mesh). The shade space texture 802 includes a set of tiles 806, which are portions of the texture 802, as described elsewhere herein. The tiles 806 include a set of texels (not shown) to be shaded (e.g., for which colors are to be determined). The scene 800 also includes a set of lights 808. The lights optionally have a direction and have a range and thus affect a light volume 810. The light volume 810 represents the volume within the scene 800 that a corresponding light 808 is said to affect. Areas outside of the light volume 810 for a light 808 are not affected by that light 808.

To shade a particular tile 806, the shade space shading operation 404 determines which lights 808 in a scene 800 contribute to the tile 806. This determination includes determining which light volumes 810 encompass the tile 806. In other words, the shade space shading operation 404 determines which lights 808 affect the tile 806 by determining which light volumes 810 the tile 806 is within. In some examples, the shade space shading operation 404 places an indication of each light 808 considered to affect the tile 806 into a light list for that tile 806. Subsequently, the shade space shading operation 404 shades the tile 806 by considering the lights 808 determined to affect the tile 806 and not considering any light 808 that is not considered to affect the tile 806. Operations for shading tiles 806 using lights 808 are very diverse and any technically feasible operation is possible. Using light lists in this manner relieves the tile shading operations from the considering every possible light 808 in the scene 800, which would incur a great deal of processing work. Determining which lights 808 are said to “affect” a particular tile 806 is sometimes referred to herein as “performing light culling for a tile 806” or with a similar phrase.

As stated elsewhere herein, the shade space shading operation 404 is not performed in screen space and thus cannot straightforwardly rely on techniques that generate light lists for tiles of the screen space. Instead, techniques provided herein rely on world space analysis to determine which lights 808 affect any particular tile.

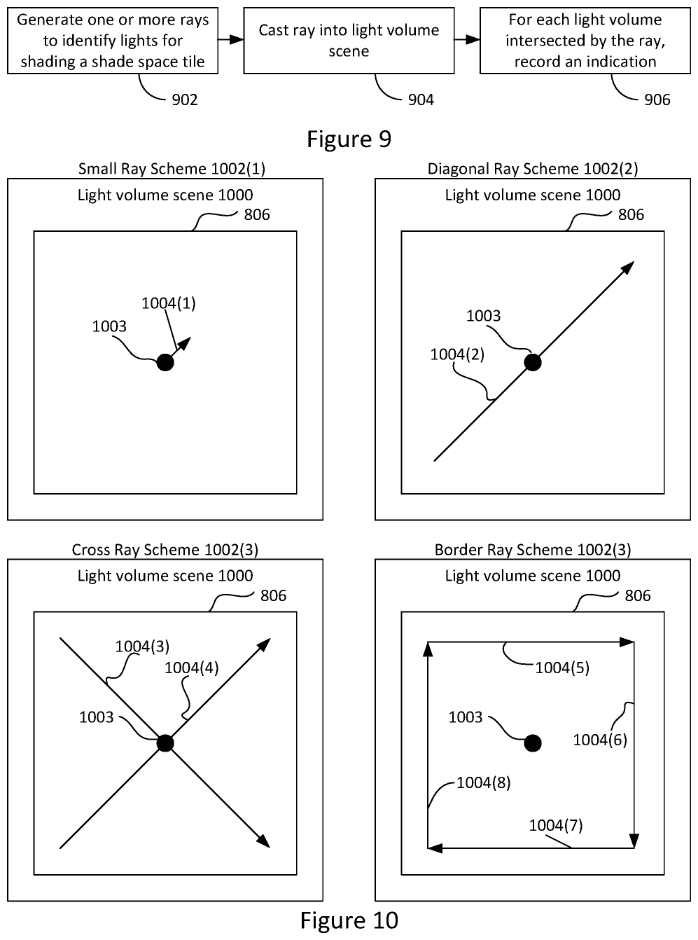

FIG. 9 illustrates an example technique for generating a light list for a tile 806 of a shade space texture 802, according to an example. The technique includes steps 902, 904, and 906. Any technically feasible processor performs the steps 902, 904, and 906. In some examples, the APD 116 performs these steps or a combination of the processor 102 and the APD 116 performs these steps. In some examples, hardware accelerated ray tracing hardware performs at least step 904 to cast a ray into a light volume scene, and in some examples, such hardware also performs step 906 (e.g., via an intersection shader, described in greater detail elsewhere herein).

The technique includes step 902, which includes generating one or more rays per shade space tile to identify lights for shading a shade space tile 806. The one or more rays are used to determine which light volumes 810 the tile 806 is within. More specifically, the rays are representative of the position and orientation of the tile 806 in world space, in the same coordinate system as that of the light volumes 810. In some examples, the rays are parallel with the tile 806, intersect the tile, or are otherwise spatially representative of the tile. The ray intersection with a light volume is a form of query that determines whether the space occupied by the ray is also occupied by any light volume 810. Additional details about generating the ray are illustrated with respect to FIG. 10.

At step 904, a processor (e.g., the APD 116) casts the one or more rays into a scene that includes light volumes 810 being queried. Casting this ray acts as a query whose response identifies the light volumes 810 the ray intersects. As the extents of the ray is representative of the geometry of the tile 806, an intersection of the ray with a light volume 810 is interpreted as an indication that the tile 806 is potentially within the light volume 810.

In some examples, at step 906, a processor (e.g., the APD 116) records an indication for each light volume 810 that is intersected by the ray. If the ray intersects a light volume 810, this is an indication that the tile 806 is affected by the light 808 associated with the light volume 810. In some examples, the processor records such an indication into a light list for the tile 806, so that after testing all or a group of tiles 806 for intersection in this manner, each tested tile has an associated light list that indicates which lights 808 of the scene 800 are considered to affect the tile 806.

Note that although the light lists are said herein to store indications of lights that “affect” a tile 806, the actual contribution of any given light 808 in a light list is determined programmatically (e.g., by the shade space shading operation 404 performing shading operations). It is possible for such programmatic determination to consider any given light in a light list but to determine that such light actually provides no contribution to a tile 806. Thus, light lists store indications of lights that are candidates for affecting a tile 806.

FIG. 10 illustrates several example schemes 1002 for casting rays to identify lights 808 of a scene 1000 to be placed into light lists. FIG. 10 illustrates examples of operation 902. Each different scheme 1002 illustrates how one or more rays are configured to perform such identification. In some examples, the shade space shading operation 404 generates such rays based on the positions and shapes of the tiles 806. In the small ray scheme 1002(1), the shade space shading operation 404 generates a ray that extends a short distance from the center or centroid (or some other point within the tile 806) of the tile 806. In some examples, the “short distance” is a significantly smaller distance than the dimensions (e.g., width, height, or diagonal) of the tile 806 (e.g., 5%, 1%, of the dimension of the tile 806). In some examples, the “short distance” is the smallest representable number in the number format in which the ray data is stored. In other examples, the ray 1004 has any other technically feasible length. In various examples, the ray 1004(1) is sized to be within the tile 806 such that determining that the ray intersects a light volume 810 necessarily means that the tile 806 is at least partially within the light volume 810.

Although a ray 1004(1) is illustrated in one example configuration, it is possible for such a ray 1004(1) to fail to detect that a tile 806 is within a light volume 810. For example, if the light volume 810 partially covers the tile 806 but does not cover any of the portion that includes the ray 1004, then the ray will not intersect the light volume 810 even though the tile 806 is at least partially within the light volume 810. Thus, other schemes 1002 for detecting whether a tile 806 is within a light volume 810 are illustrated.

In the diagonal ray scheme 1002(2), the shade space shading operation 404 generates a ray for casting, where the ray 1004(2) extends substantially from one corner to an opposite corner of the tile 806. In some examples, the ray passes through the center 1003 of the tile 806. In some examples, the ray 1004(2) extends a large percentage of the length from one corner to another, such as 75%, 80%, 85%, or another value. A larger ray 1004 than the one used in the small ray scheme 1002(1) allows for a greater portion of the tile 806 to be covered, which reduces false negatives (i.e., the situation where the tile 806 is within a light volume 810 but casting the ray 1004 does not indicate intersection with the light volume 810). Although the ray 1004(2) produces fewer false negatives than the ray 1004(1), the ray 1004(2) can still result in false negatives as there are areas within the tile 806 not covered by the ray.

Two additional schemes 1002 are illustrated as well. In the cross ray scheme 1002(3), the shade space shading operation 404 casts two rays 1004 (ray 1004(3) and 1004(4)). Each ray extends along the diagonal of the tile 806. In some examples, one or more such rays occupy a large percentage (e.g., 75%, 80%, 85% or some other significant percentage) of the length of the diagonal of the tile 806. Using two such rays further reduces the chance for false negatives but comes at the cost of requiring additional processing. In the border ray scheme 1002(3), the shade space shading operation 404 casts rays that outline an area within the tile 806, which helps to cover additional space within the tile 806 and reduce some false negatives. Again, while this scheme reduces false negatives, it comes at the cost of additional work required. It should be understood that the configuration of rays 1004 is not restricted to the schemes 1002 illustrated, and that other schemes with different ray positions, orientations, and sizes, may be used. Further, the schemes 1002 illustrated may be combined with each other and/or with other schemes 1002 not illustrated and applied dynamically as required.

One additional scheme for increasing the accuracy of the ray tracing scheme that can be used with just one ray (i.e., without increasing the number of rays as in the schemes 1002) is to increase the size of the light volumes by an estimated maximum shade tile size in the world space. In other words, the issue identified above is that rays within a tile may not be within a bounding volume representative of a light value, which could result in false negatives. However, if the BVH representation of the light volume is increased in size based on the size of the tiles in world space, then such false negatives cannot occur. Thus, in some examples, when creating the light volume (which is then converted into a BVH), the light volume is increased in size by an estimated tile size in world space. Since the tile is part of a shade space, it does not have a world space, but the tiles do ultimately correspond to portions of the world space. It is thus possible to determine the size of the tiles in world space by noting where the tiles are in world space and to increase the light volume by that size.

In some examples, the shade space shading operation 404 repeats the operations of FIGS. 9 and 10 for each tile 806 to be shaded. Thus, the shade space shading operation 404 produces a light list for each such tile 806 and then uses that light list to shade the tile 806.

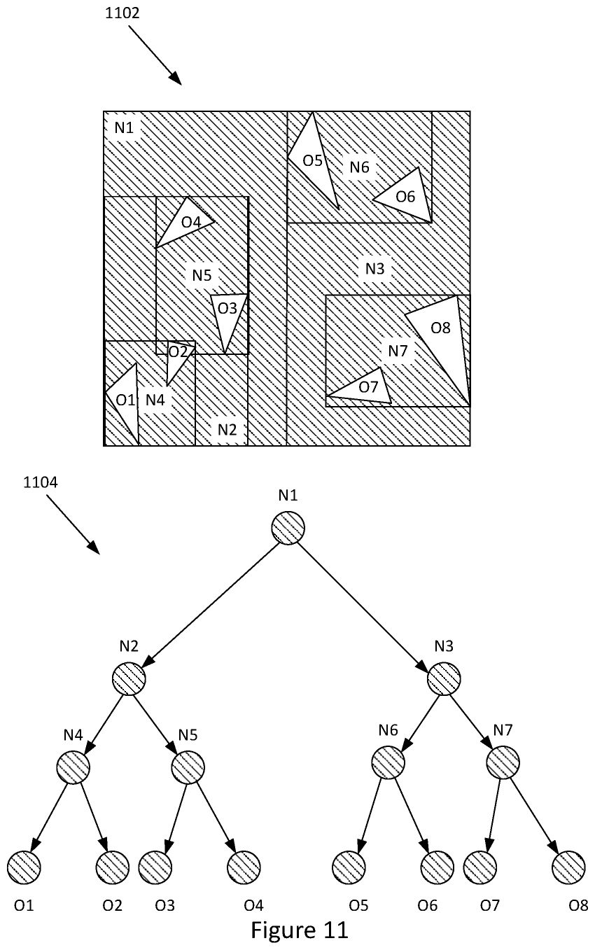

As stated above, the shade space shading operation 404 performs a ray tracing operation to detect which light volumes 810 a ray 1004 intersects. In general, the ray tracing operation utilizes an acceleration structure such as a bounding volume hierarchy to quickly eliminate large portions of a scene from consideration for the ray intersection test. In some examples, the shade space shading operation 404 (or another entity) builds one or more acceleration structures for a scene prior to performing the ray casting operations and then casts the rays for operation 904 as described elsewhere herein. An example acceleration structure is described with respect to FIG. 11.

FIG. 11 is an illustration of a bounding volume hierarchy, according to an example. Casting a ray utilizing a bounding volume hierarchy such as that illustrated is an example of operation 904. For simplicity, the hierarchy is shown in 2D. However, extension to 3D is simple, and it should be understood that the tests described herein would generally be performed in three dimensions.

The spatial representation 1102 of the bounding volume hierarchy is illustrated in the top of FIG. 11 and the tree representation 1104 of the bounding volume hierarchy is illustrated in the bottom of FIG. 11. The non-leaf nodes are represented with the letter “N” and the leaf nodes are represented with the letter “O” in both the spatial representation 1102 and the tree representation 1104. A ray intersection test would be performed by traversing through the tree 1104, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. In this example, the test would test against N₂, determining that the test fails. The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed. Note that rays can have a variety of directions and can have an origin in a variety of locations. Thus, the specific boxes eliminated or not eliminated would depend on the origin and direction of the rays. However, in general, testing the rays for intersection with boxes eliminates some leaf nodes from consideration. Although some operations of testing against a bounding volume hierarchy are described, such as testing against leaf node geometry, it should be noted that not all such operations are used for generating the light lists. Notably, it is not necessary to perform intersection tests of rays against triangles in order to build light lists, as tests against bounding volumes are sufficient.

As stated above, in some examples, the shade space shading operation 404 casts one or more rays 1004 associated with tiles 806 into a scene that includes light volumes 810, in order to determine which light volumes 810 cover a tile 806. The shade space shading operation 404 or other entity (e.g., software executing on a processor, fixed function processor, programmable processor, or other circuitry) builds a BVH similar to that of FIG. 11. For example, a non-leaf node in such a BVH describes a bounding volume that bounds the children of that node. A leaf node includes geometrical or analytical that representations of the light volumes 810. Each light volume 810 is representable by one or more leaf nodes of the BVH. In an example, a combination of leaf nodes occupies the area of one light volume 810, a different combination of leaf nodes occupies the area of a different light volume 810, and so on.

In some examples, each leaf node includes an associated bounding box and an indication of an associated intersection shader to execute in order to determine whether the ray that intersects the bounding box is considered to intersect the light volume. An intersection shader is a program (e.g., a shader) that executes on a processor such as the APD 116 (e.g., on the compute units 132) as the result of a determination that a ray intersects a node associated with the intersection shader. When a ray for a tile 806 is cast, a processor (e.g., the APD 116, the processor 102, or another entity) traverses the BVH to identify one or more leaf nodes that the ray intersects. The processor executes each intersection shader for each such leaf node. The intersection shader indicates whether the ray intersects the light volume 810 associated with the leaf node. In some examples, if there is an intersection, the intersection shader writes an indication of the light associated with that light volume 810 into a light list for the tile 806 associated with the ray. If there is no intersection, then the intersection shader does not write such an indication. As a result of casting the ray (or set of rays) for a tile 806, a light list for the tile 806 is generated. In some examples, an intersection shader is not used, and hardware capabilities for testing rays against geometry such as rectangular, conical, spheres, capsules, or other geometry, are used to test the ray for intersection at the lowest leaf node. In other words, it is possible for the lowest leaf node to specify an intersection geometry in terms of some combination of simple geometry, and then intersection with such geometry is tested to determine if the light associated with that lowest leaf node is considered to affect the tile.

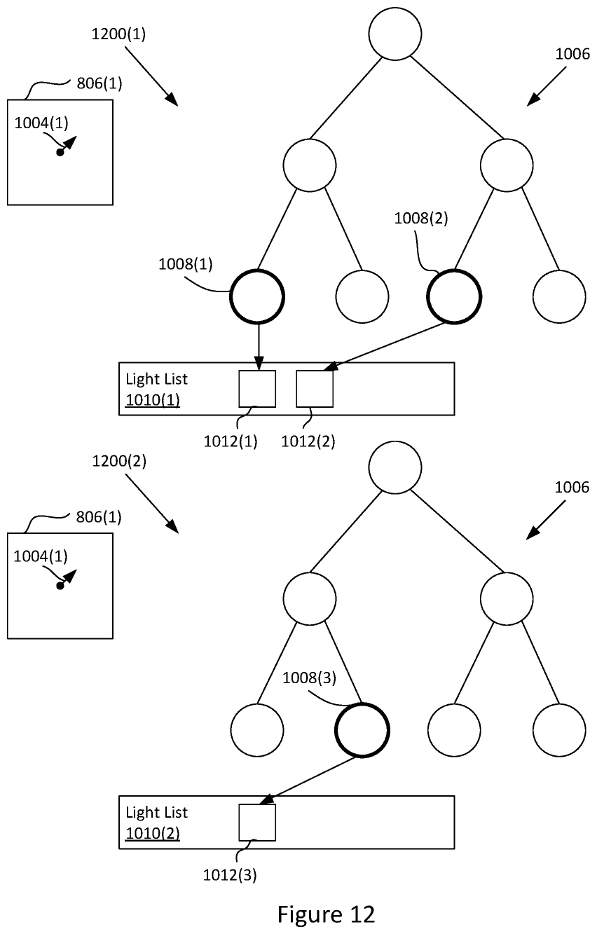

FIG. 12 illustrates an operation for building light lists, according to an example. The operations of FIG. 12 are an example of operation 906. Two ray cast operations 1200 are illustrated. In a first ray cast operation 1200(1), a first ray 1004(1) for a first tile 806(1) is cast into a scene including light volumes 810, where the scene is represented by BVH 1006. The ray cast operation indicates that the ray 1004(1) intersects light volumes 810 associated with leaf node 1008(1) and leaf node 1008(2). Thus, the shade space shading operation 404 places two light list entries 1012—those associated with the lights for the intersected light volumes 810—into the light list 1010(1) for the tile 806(1). Similarly, in a second ray cast operation 1200(2), a second ray 1004(2) for a second tile 806(2) is cast into the scene represented by the BVH 1006. The ray cast determines that the ray 1004(2) intersects the light volume 810 associated with the leaf node 1008(3) and thus places an associated entry 1012(3) into the light list 1010(2).

As described elsewhere, the shade space shading operation 404 uses the light lists 1010 to shade the texels of respective tiles 806. Such shading operations include any of a wide variety of techniques. Any such technique takes the associated lights 808 into consideration in shading the texels of the tile 806. In some examples, one or more lights 808 in the light list 1010 for a tile 806 affects the final color for at least one texel of the tile 806.

It should be understood that many variations are possible based on the disclosure herein. Although features and elements are described above in particular combinations, each feature or element can be used alone without the other features and elements or in various combinations with or without other features and elements.

In some examples, the ray tracing operations of FIGS. 10 and 11 are performed by ray tracing hardware. The ray tracing hardware includes one or more fixed-function circuits that performs at least some of the operations of traversing a bounding volume hierarchy and determining which leaf nodes a ray intersects. In some examples, the APD 116 includes such one or more fixed-function circuits. In some examples, one or more shader programs that implements at least part of the ray tracing operations executes on the compute units 132 of the APD 116. In some examples, an entity including either or both of fixed-function circuitry and shader programs traverse the bounding volume hierarchy in response to a request (e.g., from the shade space shading operation 404) to case a ray into a scene represented by the bounding volume hierarchy. This entity tests the ray against the non-leaf nodes, discarding children that are not intersected by the ray and considering children of the non-leaf nodes that are intersected by the ray. Upon arrival at a leaf node, the entity tests the ray for intersection with the leaf node in any technically feasible means such as through execution of an intersection shader as described elsewhere herein. In some examples, each intersection test is implemented in fixed-function circuitry.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, and output merger stage 318 are implemented fully in hardware, fully in software executing on processing units, or as a combination thereof. The visibility operation 402, shade space operation 404, reconstruction operation 406, ray generation 902, ray casting 904, and light list builder 906 represent activity performed by a processor such as the processor 102 or APD 116. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
generating a ray representative of an area of a tile of a shade space texture; and
casting the ray into a scene of light volumes to generate a set of lights that contribute to shading operations of the tile.

2. The method of claim 1, further comprising generating a light list including the set of lights.

3. The method of claim 1, wherein generating the ray comprises generating one of a ray that extends from the center of the tile, a ray that extends between corners of the tile, generating two rays that cross within the tile, and generating a set of rays that enclose an area of the tile.

4. The method of claim 1, further comprising repeating the generating and casting for each visible tile of a shade space texture.

5. The method of claim 1, wherein casting the ray into the scene comprises identifying which light volumes in the scene are intersected by the ray.

6. The method of claim 5 wherein generating the set of lights comprises identifying lights associated with the light volumes in the scene that are intersected by the ray.

7. The method of claim 5, wherein identifying which light volumes in the scene are intersected by the ray includes executing an intersection shader upon determining that the ray intersects a bounding volume for a leaf node.

8. The method of claim 1, further comprising shading the tile based on the set of lights.

9. The method of claim 1, further comprising building a bounding volume hierarchy corresponding to the scene of light volumes.

10. A system comprising:
a memory configured to store information for a tile; and
a processor configured to:
generate a ray representative of an area of the tile of a shade space texture; and
cast the ray into a scene of light volumes to generate a set of lights that contribute to shading operations of the tile.

11. The system of claim 10, wherein the processor is further configured to generate a light list including the set of lights.

12. The system of claim 10, wherein generating the ray comprises generating one of a ray that extends from the center of the tile, a ray that extends between corners of the tile, generating two rays that cross within the tile, and generating a set of rays that enclose an area of the tile.

13. The system of claim 10, wherein the processor is further configured to repeat the generating and casting for each visible tile of a shade space texture.

14. The system of claim 10, wherein casting the ray into the scene comprises identifying which light volumes in the scene are intersected by the ray.

15. The system of claim 14 wherein generating the set of lights comprises identifying lights associated with the light volumes in the scene that are intersected by the ray.

16. The system of claim 14, wherein identifying which light volumes in the scene are intersected by the ray includes executing an intersection shader upon determining that the ray intersects a bounding volume for a leaf node.

17. The system of claim 10, wherein the processor is further configured to shade the tile based on the set of lights.

18. The system of claim 10, wherein the processor is further configured to build a bounding volume hierarchy corresponding to the scene of light volumes.

19. A non-transitory computer-readable medium storing instructions that, when executed by a processor, cause the processor to perform operations comprising:
generating a ray representative of an area of a tile of a shade space texture; and
casting the ray into a scene of light volumes to generate a set of lights that contribute to shading operations of the tile.

20. The non-transitory computer-readable medium of claim 19, wherein the operations further comprise generating a light list including the set of lights.
